(19) United States
(12) Patent Application Publication
(10) Pub. No.: US 2004/0060853 A1
(43) Pub. Date: Apr. 1, 2004

(54) Pond fountain cartridge filter

(76) Inventor: Donald L. Dover, Christiansburg, VA (US)

Correspondence Address: MERCHANT & GOULD PC, P.O. BOX 2903, MINNEAPOLIS, MN, 55402-0903, US

(21) Appl. No.: 10/261,643

(22) Filed: Oct. 1, 2002

(51) Int. Cl. B01D 29/00; A01K 63/04

(52) U.S. Cl. 210/169

(57) ABSTRACT

A filter device and a filtration system for a pond, pool or the like. A pumping device directs water to the filter device which has an inlet check valve, retainer and filter. The filter device filters out solids from the water. Preferably, the pump does not have a pre-filler and the filter device is connected to a fountain or the like. Also, in a preferred embodiment the retainer device has a plurality of slotted openings, the filter is a foam filter and the check valve is a ball member.

### TECHNICAL FIELD

The present invention relates to filter devices and filtration systems for ponds, pools, and the like and particularly devices and systems which filter out suspended solids from water being directed to fountains.

### BACKGROUND OF THE INVENTION

There are many types of pumping and filtration systems for pools, ponds, and the like, particularly for outdoor fish and serenity ponds. Typically, a pump is used to draw water from the pond, pool, or the like and circulate it through a filtration mechanism or system and return the clean water to the pond. In traditional pond applications using water features such as a fountain, the pump is placed in the body of water and has a pre-filter integrally attached to it. The pre-filter removes solids prior to passing the water through the pump and prevents solids from entry to the fountain fixture and adversely affecting it. Such a system, however, requires significant maintenance on the pump pre-filter, which makes it necessary to remove the pump from the pond in order to remove and clean the filter. Often the pond, pool, or the like has to be drained for this purpose.

Outdoor ponds and pools, in particular, are susceptible to contaminants, such as dirt, leaves, and other materials which can be found in the water. These materials could be plant materials (such as leaves and twigs), clay, dirt, grasses, pebbles, stones, and any other material common to outdoor environments. These solids and suspended materials are difficult to filter from the pond and also can damage the pump and filtration system and/or reduce their efficiencies.

Accordingly, it is an object of the present invention to provide an improved filtration system and filtering device for ponds, pools, and the like, particularly one which allows removal and cleaning of the filtration mechanism in a faster, easier, and more efficient manner.

It is another object of the present invention to provide a pumping and filtration system in which the pumping device does not have to be removed from the body of water, or the body of water does not have to be drained.

It is still another object of the present invention to provide a filtration system and filter device for fountain fixtures and the like which does not allow suspended solids and other foreign matter to pass to or through the fountain.

These and other objects of the present invention, and solutions to the problems with known pumping and filtration systems for ponds, pools and the like, are met by the present invention.

### SUMMARY OF THE INVENTION

In accordance with the present invention, a unique filter device and filtration system are provided for a pond, pool, or the like, particularly for outdoor bodies of water which are subjected to numerous contaminants and foreign matter. The preferred filter device has a canister-type housing with a retainer member, foam filter member, and check valve. The filter member is preferably made from a material and is positioned around the retainer member. The retainer member has a plurality of openings, such as holes or slots, to allow filtered water to pass through it and exit from the housing. The check valve is preferably a ball-type valve which prevents water and contaminants from returning to the pumping member. The retainer member also preferably has a deflector in order to deflect incoming water to the housing and direct it through the filter member.

In the unique filtration system, a solids-type pumping mechanism is utilized. The pumping mechanism does not have a pre-filter which traps and prevents solid materials, such as pebbles, from passing through it. At least a portion of the water being pumped from the pond, pool, or the like by the pumping mechanism is passed through a filter device which removes any suspended solids. The filtered water from the filter device is then passed on to one or more fountain members which return the filtered water to the pond, pool, or the like through a spray. The remaining portion of the water pumped from the pumping mechanism can be returned to the body of water, routed to another filter or submitted to an aeration process, such as a waterfall.

The present invention allows for solids filtration in line with the pumping mechanism rather than traditional pre-filtration at the inlet of the pump. With the present invention, the filtration device can be easily removed from the entire system and cleaned. The present invention also eliminates the need to remove the pump from the pond to clean any pre-filters.

When using the present invention, because there are not any pre-filters to clog, a solids-handling pump can be placed in the pond and left in place, thus reducing pump and pre-filter maintenance. The filter device in accordance with the present invention can be removed from the system and cleaned in a faster and easier manner.

In an alternate embodiment, a backflush procedure can be utilized. The filter device is configured to reverse the flow through it in order to backflush the filter, thus reducing maintenance on the filter device itself.

### BRIEF DESCRIPTION OF THE DRAWINGS

FIG. 1 is a schematic view of a pump and filtration system in accordance with the present invention;

FIG. 2 is a cross-sectional view of a preferred filter device in accordance with the present invention;

FIG. 3 is an exploded view of the filter device as shown in FIG. 2;

FIG. 4 is a cross-sectional view of a portion of the filter device as shown in FIGS. 2 and 3, the cross section being taken along line 4-4 in FIG. 3;

FIG. 5 schematically illustrates the flow of water through a preferred filter device;

FIG. 6 illustrates another preferred embodiment of the present invention; and

FIG. 7 illustrates still another embodiment of the invention.

### DESCRIPTION OF THE PREFERRED EMBODIMENT(S)

The present invention provides an improved filter device and filtration system, particularly for use with outdoor ponds, pools, and the like, such as outdoor fish and serenity ponds. The filtration system provides a filter for the pond which filters solids and other suspended matter and which can be cleaned and maintained in a faster and easier manner. The present invention also minimizes maintenance of the pumping mechanism in the pond or pool which can be time-consuming and expensive.

Although the drawings and description herein depict the present invention for use with an outdoor pond or pool, it is to be understood that the present filter device and filtration system can be used to clean contaminants and suspended solids from any body of water, including aquariums. Also, although the present inventive filter device is shown and described as being a cylindrical-type and canister-type device, it is to be understood that the filter device can have any size and cross-sectional shape so long as it meets the objects and purposes of the present invention. For example, a square or hexagonal shape could be used for the filter device. The filter device also could be made of a wide variety of materials, such as plastic, stainless steel, or die cast material such as aluminum or zinc. Also, if made from a plastic material, the plastic could be injection molded, rotationally molded, blow-molded, vacuum formed, or the like. In this regard, the size and shape of the filter device, as well as the material from which it is made and the method of making the filter device are not to be limited in accordance with the present invention but are to be any shape, material, and manufacturing method known to persons of ordinary skill in the art.

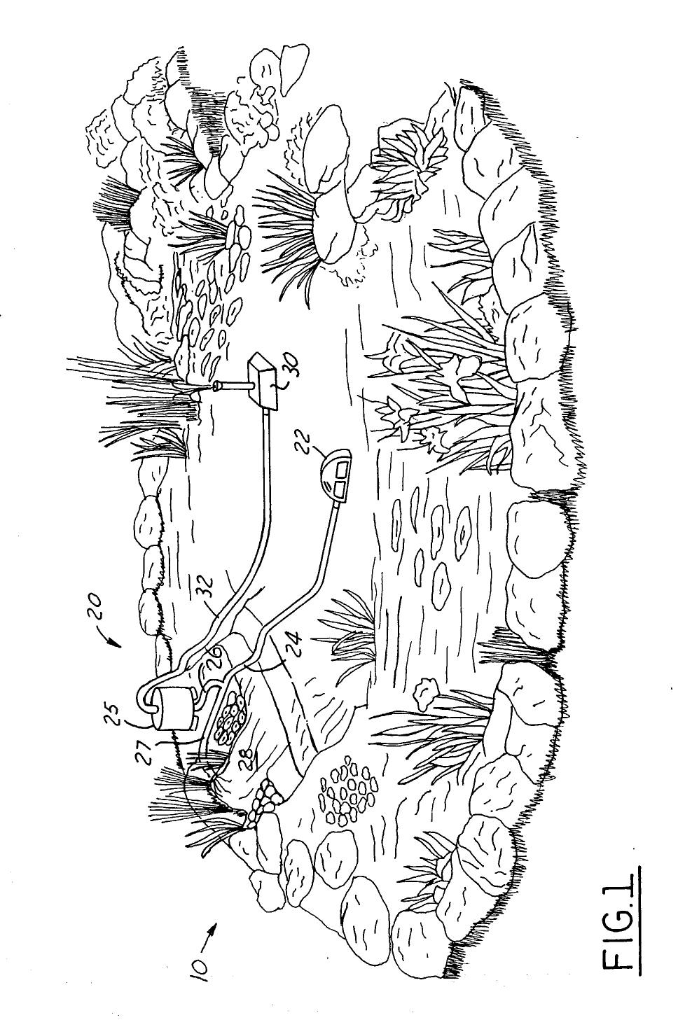

FIG. 1 illustrates a pumping and filtration system in accordance with one embodiment of the present invention when used to filter solid materials from the water in an outdoor pond. In FIG. 1, the pond is designated by the reference numeral 10, and the filtration system is designated by the reference numeral 20. As shown in FIG. 1, a pump or pumping mechanism 22 is positioned in the body of water in the pond or pool 10. The pump is connected to a conduit 24 which forces part of the water through a filter device 25 and the remainder back to the pond through a waterfall 28 or the like. Conduits 26 and 27, respectfully, are used to convey the water from the pump to the filter and to the waterfall. Filtered water exiting the filter device 25 is sent to the fountain 30. A conduit 32 connects the filter device 25 with the fountain 30.

Another preferred embodiment of the present invention is shown in FIG. 6. In this embodiment, the pump mechanism 22′ sends unfiltered water to the filter 25′ which is attached directly to the fountain member 30′. The remainder of the pumped water is passed through conduit 27′ to waterfall 28′. As indicated, only a portion of the water from the pumping mechanism is passed on to the fountain members.

It is also possible in accordance with the present invention to have a plurality of fountain fixtures or devices 30 in a pond. Separate filter devices 25 could be used for each of the fountain fixtures 30 or a single filter device 25 could be connected to two or more fountain fixtures 30.

Another embodiment of the invention is shown in FIG. 8 and designated generally by the reference numeral 150. In this embodiment, the filter mechanism 155 connected to a fountain member 158 is positioned in a float member 160 so that the filter mechanism and fountain member float at the surface 162 of the water 165. A flexible tubing member 170 is used to connect the pump mechanism 175 to the filter mechanism and fountain mechanism. A second flexible tubing member 176 is used to pass the remainder of the pumped water to waterfall 178.

The float member 160 is anchored to the bottom of the pond by a weight 180 or other heavy member. Cord or wire 185 is used to attach the weight to the float. Alternatively, the float could be attached to the pump or the side of the pond.

The pumping mechanism is preferably a solids-type pumping mechanism, which allow all of the fluids in the pond or pool, including all of the solids and other suspended foreign material, to pass through it. The pumping mechanism preferably does not have a pre-filter connected to it or integral with it. This eliminates the necessity to remove the pump or drain the pond in order to clean the pre-filter.

Pumps which can be used with the present invention include, for example, the OFX pumps marketed by Tetra Pumps, Blacksburg, Va. Other pumps of conventional types, makes, and models can be utilized with the present invention.

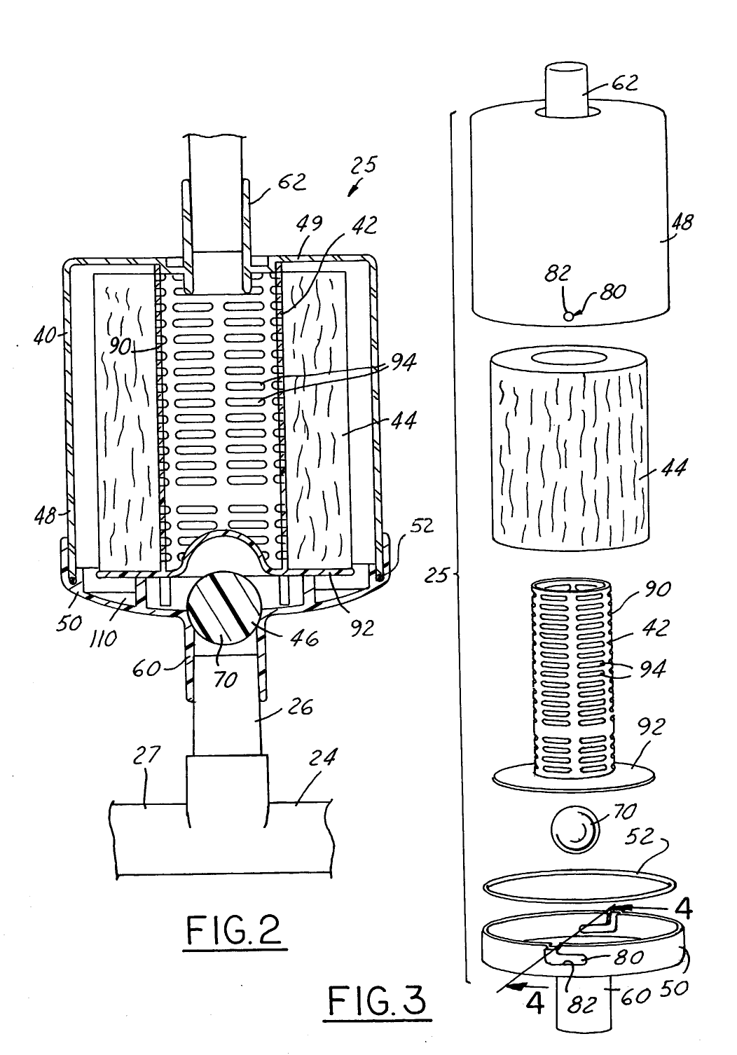

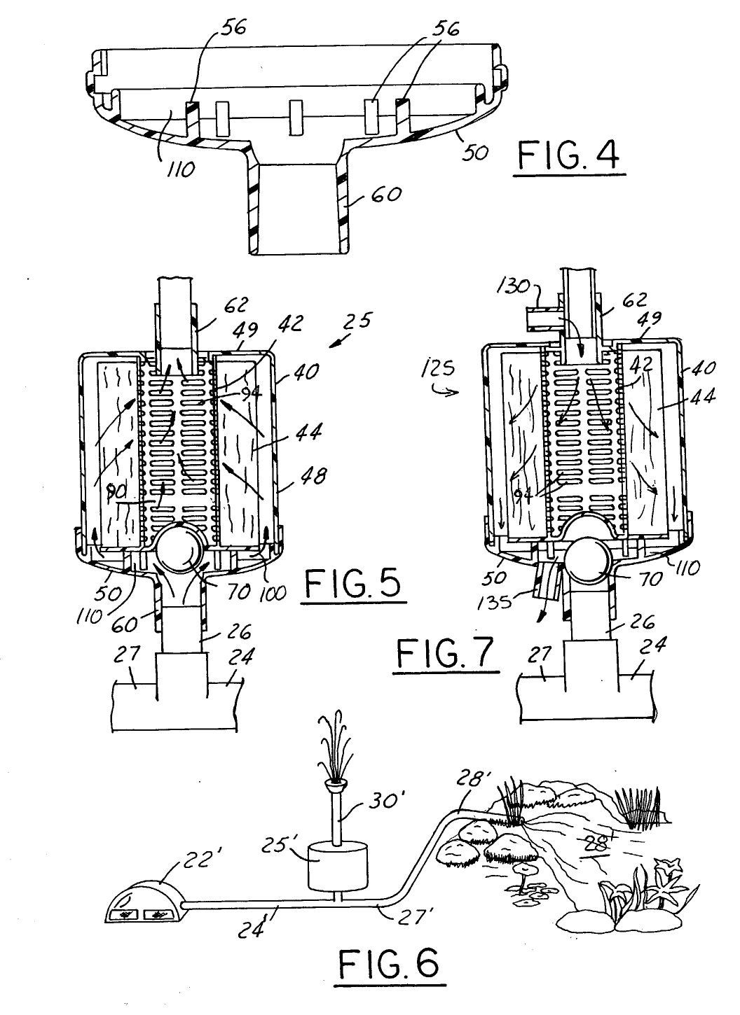

A preferred filter device is shown in FIGS. 2-5 and designated generally by the reference numeral 25. The filter device 25 has a housing 40, a perforated retainer member 42 positioned inside the housing, a filter member 44 positioned on the retainer member 42, and a ball-type check valve 46. The housing 40 preferably has a canister-type member 48 and a removable cap or lid member 50 attached to it. A sealing member, such as O-ring 52, is used to seal the canister 48 and cap 50 when they are fastened together, as shown in FIGS. 2 and 5.

The housing 40 has an inlet 60 at one end and an outlet 62 at the other end. The check valve 46 is positioned at the inlet 60 of the housing 40 and preferably is a ball-type check valve having a ball member 70. The ball member 70 is provided of a size and diameter such that it seals off inlet 60 when it is positioned as shown in FIG. 2. This prevents fluids and contaminants in the housing 40 from being returned to the pumping mechanism 22.

The filter member 44 is preferably made of a foam-type material. The foam member 44 has a hollow, cylindrical shape for positioning around the exterior of the retainer member 42.

The cap member 50 is connected to the canister member 48 and the two members are secured together by a bayonet-type mating/securing mechanism 80. For this purpose, a pair of opposed pin members 82 are provided on the exterior surface of the canister member 48 and a pair of J-shaped slots 84 are provided the cap member 50. It is understood, of course, that other mating and securing mechanisms for joining together the cap and canister member can be utilized, such as threaded connections, snap-fit connections, and the like. It is also possible for the filter device to have a one-piece housing or integral housing and can be disposed of when it becomes clogged and ineffective.

The retainer member 42 includes a hollow tubular member 90 and a lower flange member 92. The tubular member 90 has a plurality of openings, such as holes or slots 94, in order to allow filtered water passing through the filter member 44 to enter the hollow interior of the tubular member 90 and exit through outlet 62 in housing 40. For this purpose, a large number of slots, openings, or the like can be provided in the retainer member 42.

The flange member 92 acts as a deflector for water entering the housing 40 through the inlet 60. As shown in FIG. 5 by the arrows 100, water entering the inlet 60 forces the ball member 70 away from its seat in the opening, and is deflected by the flange 92 toward the inner walls of the housing 40. The water is forced through the foam filter member 44, through the openings 94 in the retainer member 42, and out outlet 62. Any solids or other contaminants suspended in or part of the flow of water into the filter device 25 are captured by the filter member 44 or are settled out in the cavity 110 in the cap member 50.

A series of posts or projection members 56 in the cap member 50 are used to hold the retainer member 42 in place and hold it tightly against the opposite surface 49 of the housing 40.

Although two embodiments of the inventive filtration system are shown in FIGS. 1 and 6 and described above, it is obvious that other embodiments could be utilized within the skill of persons in the art. For example, as indicated above and shown in FIG. 8, the filter device could be attached to the pump by a flexible tube and configured with a float member and placed anywhere in the pond. When the filter device needs to be cleaned or maintained, the floating member with the filter device on it could be pulled onto the bank of the pond or edge of the pool by a cord or other member (not shown).

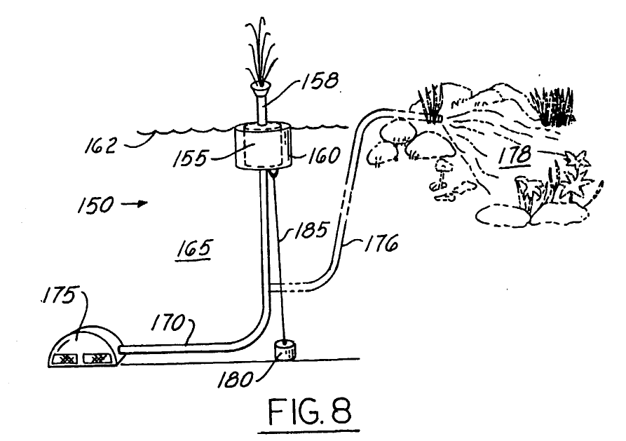

The filter device 25 could also be made on a larger scale to be used as the primary filter for removal of solids from the entire volume of water from a pond, pool, or the like. Filter devices for filtering all water from a body of water would also preferably include a backflush system in order to clean the internal filter member and flush out solids and other contaminants collected in the device. In this regard, a preferred device of this type is shown in FIG. 7 and designated by the reference numeral 125. For use as a filtration mechanism, the components are the same as those described above with reference to filter device 25 and are used in the same manner. When it is desired to backflush and clean the filter device 125, water and other cleaning fluids from a hose or the like is introduced through inlet 130 and forced out through outlet 135. The backflush essentially reverses the direction of flow through the filter device. The clean water is forced through the openings 94 in the retainer member 42, through the filter member 44 and out through the outlet 135. This removes any materials which are suspended on the exterior of or interior of the filter member 44 and also removes any solids, such as pebbles and the like which are collected in the space 110 in the cap member 50. Removable cap or plug members (not shown) are used to close and seal the ends of the inlet 130 and outlet 135 during normal filtering operation of the device 125.

Although the preferred embodiment utilizes a ball-type check valve 46, it is to be understood that any type of check valve arrangement or mechanism could be utilized with the present invention, so long as the valving mechanism prevents fluids and contaminating solids, such as pebbles and dirt, from returning back to the pumping mechanism.

While particular embodiments of the invention have been shown and described, numerous variations and alternate embodiments will occur to those skilled in the art. Accordingly, it is intended that the invention be limited only in terms of the appended claims.

What is claimed is:

1. A filter device for filtering suspended solids from fluids comprising:
a housing having an inlet and an outlet;
a hollow retainer positioned in said housing, said retainer having a plurality of openings therein and being in fluid communication with said housing outlet;
a filter positioned on said retainer for filtering out suspended solids from fluids passing through it; and
a check valve at said housing inlet.

2. The apparatus as set forth in claim 1 wherein said filter is made of a foam material.

3. The apparatus as set forth in claim 1 wherein said filter has a cylindrical shape with a passageway therein for placement of said retainer.

4. The apparatus as set forth in claim 1 wherein said plurality of openings in said retainer comprises a plurality of slots.

5. The apparatus as set forth in claim 1 wherein said retainer further comprises a fluid deflector positioned adjacent said housing inlet for deflecting fluids entering said housing.

6. The apparatus as set forth in claim 1 wherein said check valve comprises a ball member adapted to mate with said housing inlet.

7. The apparatus as set forth in claim 6 wherein said retainer has a recess therein for retention of said ball member.

8. The apparatus as set forth in claim 1 wherein said housing comprises a canister member and a mating cap member.

9. The apparatus as set forth in claim 8 wherein said canister member and said cap member are releasably secured together, wherein said cap member can be separated from said canister member to allow removal and cleaning of said filter.

10. A filtration system for a pond, pool or the like comprising:
a pumping device for pumping fluid from the pond, pool or the like;
a filter device in fluid communication with said pumping device and adapted to receive fluids from said pumping device and filter out suspended fluids;
said filter device comprising a housing with a filter member positioned in said housing; and
means for returning filtered fluids from said filter device to the pond, pool or the like.

11. The filtration system as set forth in claim 10 wherein said pumping device is a solids pumping mechanism.

12. The filtration system as set forth in claim 10 wherein said means for returning filtered fluids comprises at least one fountain member in fluid communication with said filter device.

13. The filtration system as set forth in claim 10 wherein said filter device further comprises a retainer for securing said filter member in said housing.

14. The filtration system as set forth in claim 13 wherein said retainer is hollow and has a plurality of openings therein for entry of filtered fluids.

15. The filtration system as set forth in claim 10 wherein said filter device further comprises a check-valve for preventing fluids in said housing from returning to said pumping device.

16. The filtration system as set forth in claim 15 wherein said check valve is a ball-type check valve mechanism.
